(19) United States
(12) Patent Application Publication
(10) Pub. No.: US 2015/0316947 A1
(43) Pub. Date: Nov. 5, 2015

(54) TRANSFER SWITCH WITH MAXIMUM POWER LEARN FUNCTION

(71) Applicant: Milbank Manufacturing Co., Kansas City, MO (US)

(72) Inventors: Paul Creekmore, Kansas City, MO (US); Jason David Bridges, Kansas City, MO (US); Bowe Neuenschwander, Kansas City, MO (US); David Lawrence Oldroyd, Kansas City, MO (US)

(73) Assignee: Milbank Manufacturing Co., Kansas City, MO (US)

(21) Appl. No.: 14/702,343

(22) Filed: May 1, 2015

Related U.S. Application Data
(60) Provisional application No. 61/987,999, filed on May 2, 2014.

(51) Int. Cl. G05F 1/66; G05B 15/02

(52) U.S. Cl. CPC G05F 1/66; G05B 15/02

(57) ABSTRACT

Aspects of the present disclosure involve systems, devices, methods, and the like, for a transfer switch of a power system incorporating a self-powered electronic meter that provides a learn function to determine the maximum amount of power an attached generator can provide, and adjust a power meter display associated with the switch accordingly so that the indicator of the display may be used for any size generator and display the full range of the generator. The learning function is activated and a user turn on devices and loads in the load center until the generator stalls. A microcontroller records the max generator power that was measured before the generator stalled and save it to non-volatile memory as the new 100% setting for that particular generator connected to the transfer switch.

### Cross-Reference to Related Applications

This application claims priority under 35 U.S.C. §119(e) to U.S. Provisional Application No. 61/987,999 entitled “TRANSFER SWITCH WITH MAXIMUM POWER LEARN FUNCTION”, filed on May 2, 2014 which is incorporated by reference in its entirety herein

### TECHNICAL FIELD

Aspects of the present disclosure generally relate to systems and methods related to providing and managing utility power sources. More specifically, the present disclosure relates to a manual transfer switch to transfer an electrical load between two or more separate power systems and configured to determine or learn a maximum power capacity of an alternative power source.

### BACKGROUND

Generators are often used in certain situations to feed electrical power to residential and/or commercial load circuits during a utility power outage. Thus, during a power outage, a power transfer switch may switch the power supply to the residential and/or commercial load circuits from the utility source to the backup generator. As shown in FIG. 1 and as understood to be conventional in power transfer devices, a generator 104 is typically connected to a power inlet box 106 mounted to an exterior wall of a building. The power inlet box 106 is further electrically connected to a transfer switching mechanism 108 that continues the electrical path through circuit breakers associated with the transfer switching mechanism to supply power to certain selected circuits of the load circuit in the main switch panel as determined by the transfer switching mechanism circuit breakers 110. The circuits of the transfer switching mechanism 108 are wired to selected circuits of the load center, through wiring housed within a conduit extending between the load center and the transfer switching mechanism. Thus, through manual operation of the switches in the transfer switching mechanism, a user of the system can select between utility power supplied to the load circuit through a utility meter 102 and generator power supplied by the generator 104 to power the selected circuits of the load center. As an example, during a utility power outage, a user may start up the generator and manually switch the input electrical power from utility power to generator power in order to restore power to pre-designated, critical circuits (e.g., hot-water heater, refrigerator).

It is also often desirable to provide a power meter on the front panel of the transfer switch. The power meter allows a user to monitor the amount of power provided by a generator during a power outage so as to prevent overloading of and possible damage to the generator and/or building electrical system. For example, depending on the kilowatt rating attributed to a user's generator, applying the power from the generator to too many circuits or to too high a load may cause the generator to overload and shutdown. Thus, it is often helpful to the user to be able to monitor the power provided by the generator to the load through one or more power meters to ensure that overloading does not occur, especially during those times when other power may not be available to energize the circuits of the house.

It is with these and other issues in mind, among others, that various aspects of the present disclosure were conceived and developed.

### SUMMARY

One implementation of the present disclosure may take the form of a method for calibrating a power meter of a power transfer device. The method may include the operations of monitoring a provided power from a power source in electrical communication with the manual transfer device, detecting an overload condition of the power source, and storing a maximum power level of the power source in at least one memory device of a power meter display control circuit, the maximum power level of the power source associated with the overload condition of the power source. The method may also include the operations of calculating a percentage of the maximum power provided to a load center connected to the power transfer device from the power source, the percentage of the maximum power comprising a current power provided by the power source to the load center divided by the maximum power level of the power source and displaying the calculated percentage of maximum power on the power meter associated with the manual transfer device.

Another implementation of the present disclosure may take the form of a manual transfer switch. The manual transfer switch comprises a switch comprising a first position that provides power from a first power source to a load center in electrical communication with the manual transfer switch and a second position that provides power from a second power source the load center, a power meter for displaying an indication of a power level of the power source provided to the load center, and a control circuit. The control circuit includes a processor and at least one memory device, with the processor executing one or more instructions stored in the at least one memory device. When executed, the instructions cause the control circuit to monitor the second power source for an overload condition of the second power source, detect the overload condition of the second power source, and store a maximum power level of the second power source in the at least one memory device, the maximum power level of the second power source associated with the overload condition of the second power source. The instructions also cause the control circuit to calculate a percentage of the maximum power provided to the load center from the second power source, the percentage of the maximum power comprising a current power provided by the second power source to the load center divided by the maximum power level of the second power source. The indication of the power level of the second power source provided to the load center is the calculated percentage of maximum power.

Yet another implementation of the present disclosure may take the form of a system for providing power to a site. The system includes a generator, a load center, and a manual transfer switch in electrical communication between the generator and the load center. The manual transfer switch includes a power meter for displaying an indication of a power level of the generator provided to the load center and a control circuit comprising a processor and at least one memory device, the processor executing one or more instructions stored in the at least one memory device. When executed the instructions cause the control circuit to monitor a provided power level from the generator for an overload condition of the generator, store a maximum power level of the generator in the at least one memory device, the maximum power level of the generator associated with the overload condition of the generator, and calculate a percentage of the maximum power provided to the load center from the generator, the percentage of the maximum power comprising a current power provided by the generator to the load center divided by the maximum power level of the generator.

### BRIEF DESCRIPTION OF THE DRAWINGS

Aspects of the present disclosure may be better understood and its numerous objects, features, and advantages made apparent to those skilled in the art by referencing the accompanying drawings. It should be understood that these drawings depict only typical embodiments of the present disclosure and, therefore, are not to be considered limiting in scope.

FIG. 1 is an example of a dual-power system that receives power from a utility and a generator

FIG. 2 is a front view of an example transfer switch.

FIG. 3A is a front view of a faceplate of a transfer switch incorporating a power meter display with a learn function interface.

FIG. 3B is a side view of a faceplate of a transfer switch incorporating a power meter display with a learn function interface.

FIG. 3C is a back view of a faceplate of a transfer switch incorporating a power meter display with a learn function interface.

FIG. 4 is a flowchart of a method for activating a learn function of a transfer switch such that the transfer switch obtains an operating range of a generator associated with the transfer switch.

FIG. 5 is a flowchart of a method for a transfer switch to learn an overload power rating for an associated generator.

FIG. 6 is a flowchart of a method for utilizing the display of a power meter of a transfer switch when a load center is energized by a utility power to maximize the loaded circuits for the situation where the load center is powered by a generator.

FIG. 7 is an exemplary control circuit configuration for performing one or more of the operations of a transfer switch system.

FIG. 8 is a schematic of one embodiment of a power meter circuit for a power transfer switch with a learn function.

### DETAILED DESCRIPTION

Aspects of the present disclosure involve systems, devices, methods, and the like, for a transfer switch of a power system to transfer between two or more power sources. In particular, the transfer switch incorporates a self-powered electronic meter that provides a function or feature to learn the maximum amount of power an attached generator (or other alternative power source) can provide, and adjust a power meter display associated with the switch accordingly so that the indicator of the display may be used for any size generator and display the full range of the generator. Typically, transfer switches use a fixed power gauge that has no knowledge of the maximum power available from the alternative power source such that a user of the transfer switch must know the maximum power they can safely use when power is provided by the alternative power source. In particular and as described above, many generators will stall or overload when too many circuits or too high a load is electrically connected to a generator. Thus, to ensure that the generator can power the loads applied to the transfer switch under generator power, a user of the transfer switch must know the upper limit of power that the generator may apply before stalling and ensure that the loads applied to the generator power do not exceed the maximum amount of power of the generator.

In contrast, the power meter display of the present disclosure transfer switch eliminates the need for the user to understand or know the power rating of their generator and simply adjusts a power meter display on the transfer switch to the proper operating range for the connected generator. This learning function is done from a simple process of activating a learn mode of the power meter, and then having the user turn on devices and loads in the load center (such as one or more circuits of a house) until the generator stalls. A microcontroller records the max generator power that was measured before the generator stalled and save it to non-volatile memory as the new 100% setting for that particular generator connected to the transfer switch. Further, any time the generator is serviced or replaced, the user can re-run the learn mode to readjust the power meter display to correspond to the attached generator. In this manner, the transfer switch power meter may adjust the range indicated by the meter display for the various types of generators that may be connected to the load center through the transfer switch.

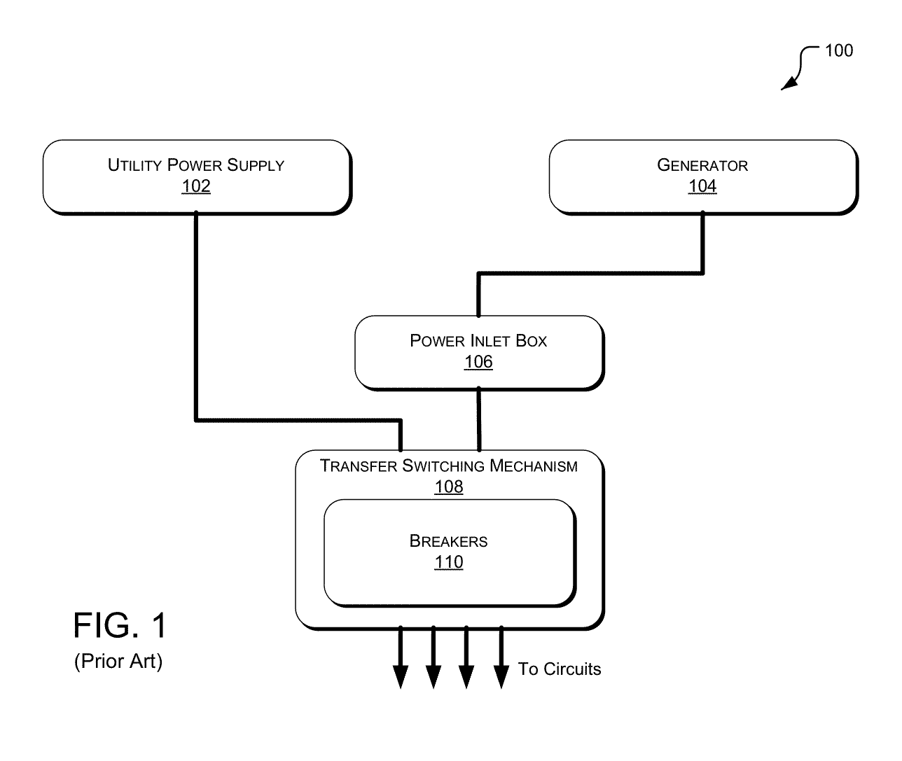

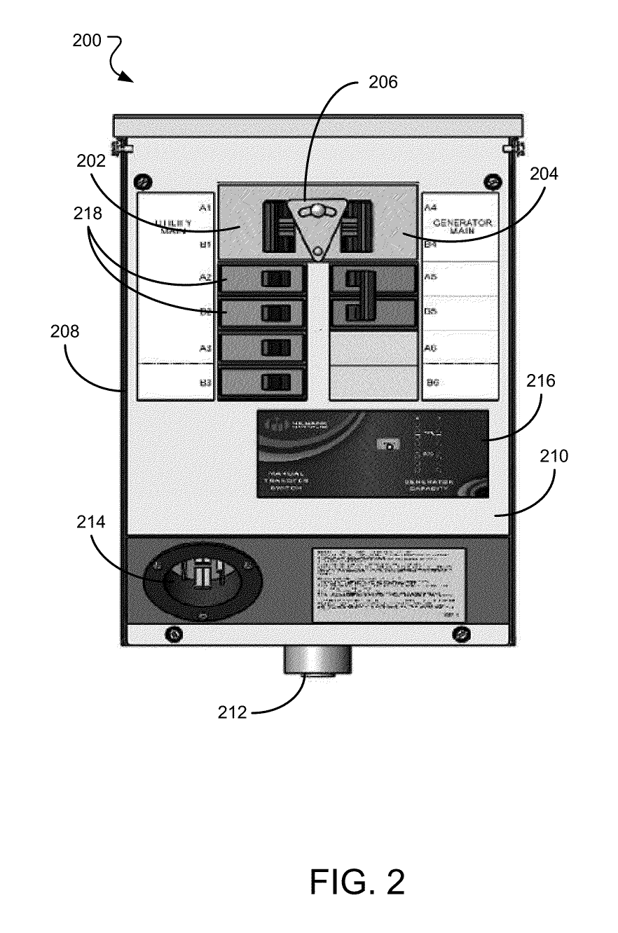

FIG. 2 is a front view of an example transfer switch 200, such as the transfer switch mechanism 108 of FIG. 1. In general, the transfer switch 200 connects two or more power sources to a load center, such as a home or commercial building. In one particular example used herein, the transfer switch 200 allows a user to switch between a utility power source and an alternative power source, such as a generator, for providing power to the load center. It is often the case that the transfer switch would be used when there is a power failure at the load center location. In the case of a home, the load center might include a refrigerator circuit, some light circuits, a hot-water heater circuit, and other circuits that have need for power during a failure. In general, however, any type and number of circuits may be powered by the generator as determined by a user of the transfer switch, as long as the circuits do not draw too much of the available generator power and cause the generator to stall.

The transfer switch 200 includes interfaces for connecting the power sources to the transfer switch. For example, the transfer switch 200 includes a first connector 202, such as a breaker switch, to which a utility power source may be electrically connected. In addition, the transfer switch 200 may include a second connector 204 to which an alternative power source, such as a generator, may be electrically connected. In one embodiment, an interlock device 206 is utilized between the first connector 202 and the second connector 204 to ensure that only one power source is powering the load center at any one time. This interlock 206 prevents unsafe conditions that may cause fire, electrocution, damage to the load center or many other unsafe conditions.

During an outage of utility power (or for any other reason), a user of the transfer switch 200 may operate the breaker switch of the first connector 202 to remove an electrical connection between the utility power source and the load center (or powered circuits). In addition, the user may activate the breaker switch of the second connector 204 to provide an electrical connection between the generator power source and the load center. In one embodiment, the disconnection of the utility power source to the load center and the connection of the generator power source to the load center may occur simultaneously. Once the second connection 204 is activated, the circuits of the load center are powered by the generator power source. In some embodiments, the generator power source may be any type of power source, including wind power, solar power, or an additional utility power source.

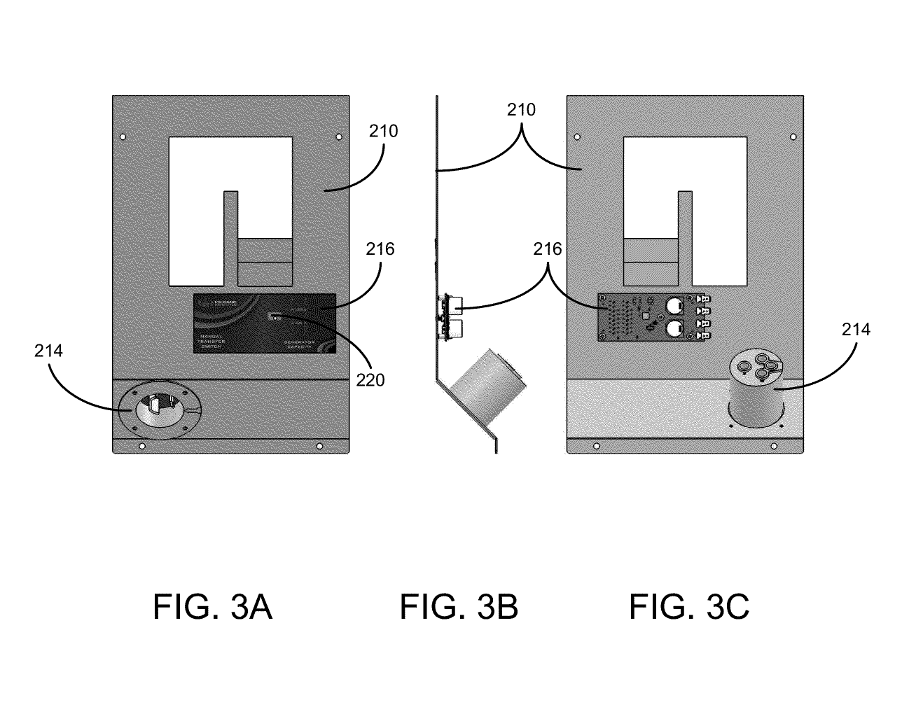

In general, the transfer switch includes a rectangular housing 208 and a faceplate 210 mounted within the housing. The faceplate 210 may include one or more cutouts for one or more breakers 218, a plug interface 214 for receiving power from a generator and an LED meter 216. The aspects of the faceplate 210 and the various components associated with the faceplate are discussed in more detail below with reference to FIGS. 3A-6.

To connect the transfer switch 200 such that the switch can provide power to the load center, utility wires from the load center connect to a set of breakers 218 from an opening 212 in the bottom of the housing 208. Output wires to the load center are also passed through the opening 212 in the bottom of the housing 208. Activation of a combination of the power switches 202, 204 and the breakers 218 connected to the load center allow a user of the transfer switch 200 to provide power to various circuits of the load center from utility power source or the alternative power source. However, as mentioned, the power available from the alternative power source, such as a generator, may be limited such that drawing too much power from the alternative power source may cause the generator to overload or stall. Therefore, the transfer switch 200, in particular the faceplate 210 of the transfer switch, may include a power meter 216 that provides an indication of the percentage of maximum power available from the generator being provided to the circuits of the load center. Various aspects of features of the meter 216 are described below.

FIG. 3A is a front view, FIG. 3B is a side view, and FIG. 3C is a back view of the faceplate 210 of a transfer switch 200 incorporating the meter 216. In general, the meter 216 includes a plurality of LED indicator lights disposed on the meter that provide a visual indication of the power being provided to the load center from either the utility power source or the alternative power source. In the embodiment illustrated in FIGS. 2 and 3A-3C, the LED meter 216 includes a series of light emitting diodes (LEDs) that indicate an approximate power provided to the load center. In particular, the LEDs are activated and deactivated to indicate the power being provided. It should be appreciated, however, that any type of power meter display may be incorporated into the transfer switch 200 as long as the display provides some indication of the amount of power provided to the load center. For example, the display may be a digital read-out of the power provided, an analog meter display, an auditory indicator, and the like.

In one particular embodiment, the power meter display 216 may provide an indication of the power provided to the load center as a percentage of the maximum power available from the alternative power source, such as a generator. In other words, the spectrum displayed by the power meter display 216 ranges from 0% to 100% of the available power from the generator. In the embodiment that utilizes an LED display, the LEDs of the display may be arranged in a vertical fashion where the bottom-most LED indicates that 0% of the power of the generator is being provided to the load center and the upper-most LED indicates that 100% of the power of the generator is being provided to the load center. As such, the various LEDs of the display provide an indication of the percentage of the generator power being consumed by the load center. In general, the percentages of the generator power indicated on the power meter display 216 may include any percentage range, including those exceeding 100% of the generator power. The LED power display 216 of the transfer switch device is described in more detail in related concurrently-filed patent application titled “LED Meter Board for a Transfer Switch” to Creekmore et al., Attorney Docket No. MIL228-491918, which is incorporated in its entirety herein.

As mentioned, the transfer switch 200 allows for a user to select between two power sources, in some instances a utility power source and a generator power source. However, not all generators operate in the same manner or provide the same amount of power to a load center. For example, a smaller generator may provide 3 kilowatts (kW) of power, while a larger generator may provide up to 12 kW of power or more. This variability in the amount of power different types of generators are capable of providing to the load center provides some difficulty in transfer switches that include a power meter 216, especially for those power meters that display a percentage of the provided power of the overall available power from the generator. In other words, 3 kW of power provided from a 3 kW generator should be indicated on the percentage meter display 216 as 100% of the power, where 3 kW of power provided from a 12 kW generator should be indicated on the percentage meter display as 25% of the available power. Further, power meters of a transfer switch that do not display percentages of available power but rather the total power provided by the generator may not be capable of displaying the uppermost limit of power provided by a large generator. Adjustment of the range of power displayed by the power meter display of the transfer switch may improve the accuracy of both percentage power meter displays and overall power meter displays.

To account for the variability of generators that may be connected to the transfer switch device by a user of the device, transfer switches 200 may adjust the range of power displayed by the power meter to the specific type of generator connected to the switch. In the embodiments of the transfer switch 200 that includes a percentage power meter, the range of the display of the power meter may be adjusted accordingly to account for the range of power available from the generator. As such, described herein is a transfer switch 200 that includes a learning function or feature through which the power meter display 216 may adjust the range of the displayed power provided to a load center based on the particular generator connected to the switch.

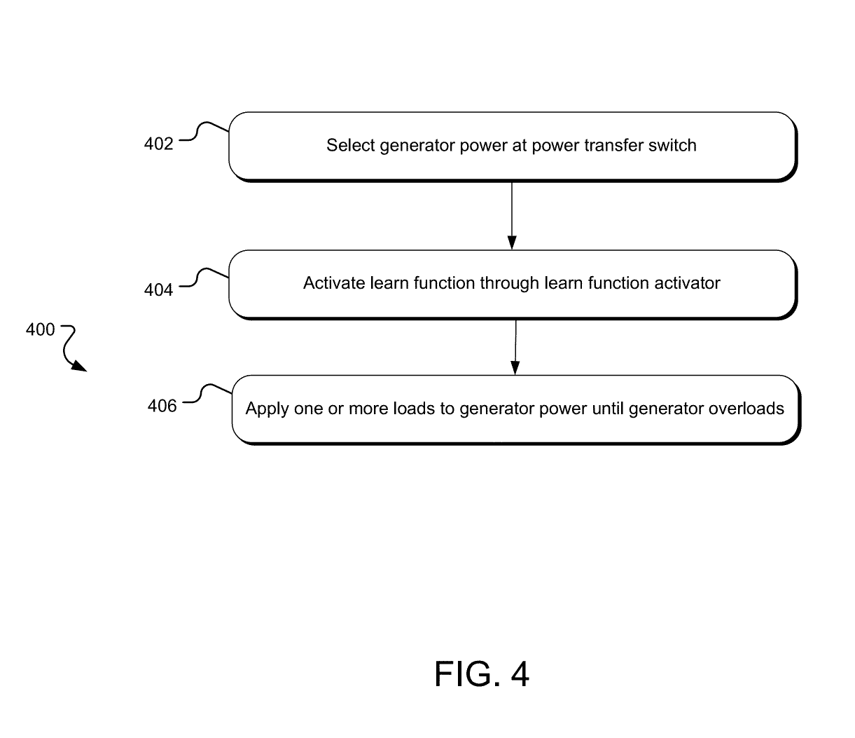

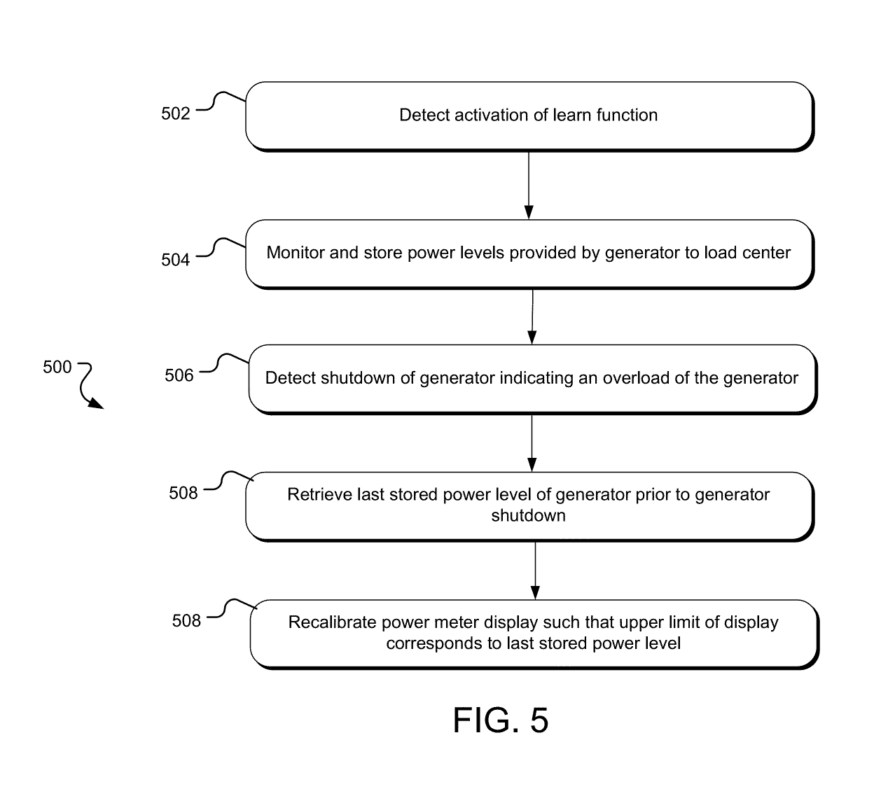

FIG. 4 is a flowchart of a method for activating a learn function of a transfer switch such that the transfer switch determines an operating range of a generator associated with the transfer switch. In general, the operations of FIG. 4 are performed by a user of the transfer switch, or may be performed by a system associated with the transfer switch to automatically perform the operations described in conjunction with the learn function of the transfer switch. Similarly, FIG. 4 is a flowchart of a method for the transfer switch 200 to learn an overload power rating for an associated generator to the switch. Thus, used in conjunction, the operations of FIG. 4 and FIG. 5 describe the process through which a user of the transfer switch can perform the learning function of the transfer switch. As such, the operations of both flowcharts are discussed below.

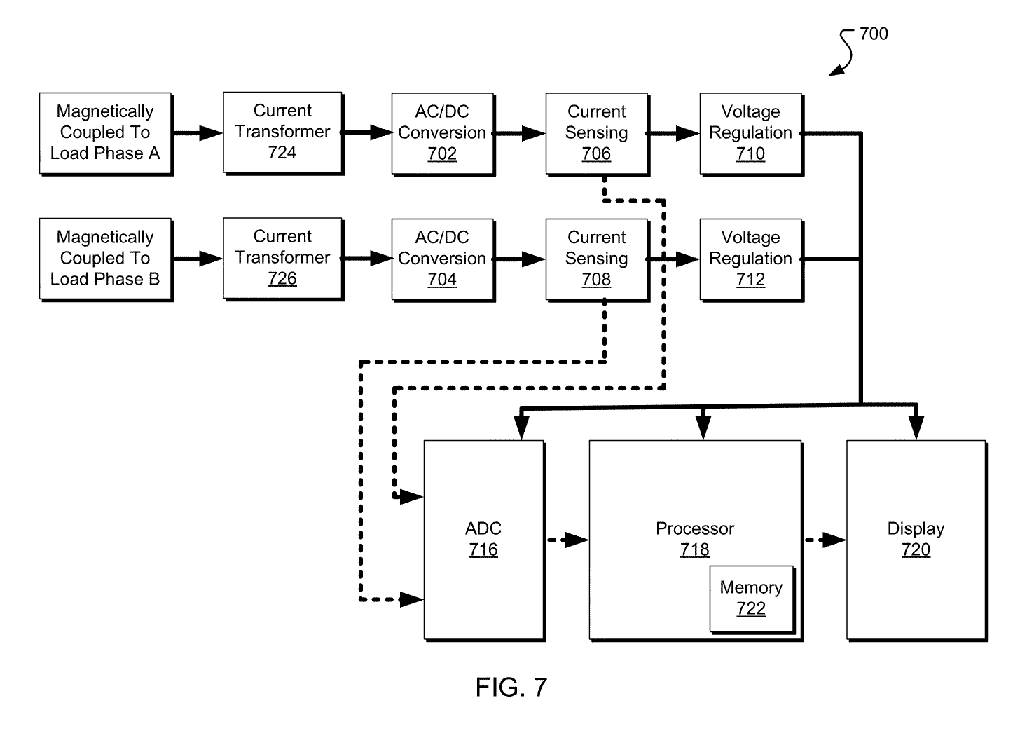

In general, the learning function described in FIGS. 4 and 5 is utilized by the transfer switch 200 to determine the output capabilities of a generator associated with the switch and adjust a power meter display accordingly. The power meter display 216 of the transfer switch 200 may indicate the power being consumed by a load center as a percentage of the overall power output capability of the generator, as described above. Further, the operations of FIG. 5 may be performed by the transfer switch 200, and more particularly by a circuit or control board associated with the switch. Such a circuit is described in more detail below with relation to FIG. 7.

Beginning in operation 402, the user or the system of the transfer switch 200 utilizes the connections and breakers of the switch to select generator power (or other alternative power source) to power or otherwise energize the load center connected to the switch. This operation thus energizes the circuits of the load center solely through the power provided by the generator. Other operations, such as starting of the generator and connecting the generator to the transfer switch, may also be performed prior to operation 402 to provide power to the load center from the generator. Once generator power is selected, the user or the system begins the learn function of the switch by activating the learn function activator in operation 404. In one embodiment, the learning function is activated through a learning function activator 220, such as a push button, located on the power meter display 216 or the transfer switch faceplate 210 or otherwise accessible by a user of the transfer switch. In general, any activation switch 220 or indicator may be utilized to begin the learning function. For example, the activator 220 may be a simple on-off switch. In another example, the activator 220 may be an automatic activator that begins the learning function based on one or more monitored operating conditions of the transfer switch. In this embodiment, when the control circuit detects a new or upgraded generator connected to the switch, the activator 220 may be activated to begin the learning function of the transfer switch.

Turning now to operation 502 of FIG. 5, the control circuit of the transfer switch 200 detects activation of the learning function and, in operation 504, begins monitoring and storing power levels provided by the generator to the load center. Because generator power is selected to provide power to the load center as discussed above, the power levels being monitored and stored by the control circuit are the power levels being provided by the generator to the load center. The monitoring and storing of the power level may be performed by the control circuit by converting the detected power as an input to the power meter display 216, converting the detected power into a digital representation of the power level and storing the converted representation in one or more memory components of the control circuit. In one embodiment, larger values of detected power levels may be stored in place of detected lower values such that only the largest power level value is maintained in the memory.

Returning to the flowchart of FIG. 4, the user or the system begins applying more load to the load center in operation 406. This may include energizing additional circuits, appliances or other energy consuming devices on the power provided by the generator. In one embodiment, the user or the system may continue adding load to the load center until the generator is overloaded and shuts off. In general, typical generators include a fail-safe feature that prevents damage to the generator when too much load is applied to the generator such that the load requirement is greater than the maximum power rating for the generator. Typically, this fail-safe feature includes stalling or shutting down of the generator.

In operation 506 of FIG. 5, the control circuit 216 detects this generator shut-off in response to the overloaded generator. In one embodiment, the control circuit 216 may include circuitry or software that determines when the power provided by the generator drops to zero, thereby indicating generator shut-off. Once the shut-off indicating a generator overload is detected, the circuit retrieves the last saved power level value from the memory associated with the control. The last saved power level stored in the memory is the same or similar to the cutoff power level for the generator. In other words, the last stored power level equals or is similar to 100% of the available power from the generator to the load center before the generator stalls or shuts down.

The control circuit may use this last saved power level to recalibrate the power meter and power meter display 216 of the transfer switch in operation 510. In particular, the control circuit may determine that the last saved power level is similar to the 100% of the available power from the generator. Thus, in power meter displays 216 where 100% of the available power is displayed, the upper limit to the power meter display may be equated to the last saved power level. In the example of the LED power meter display 216, the control circuit may equate the upper-most LED with the last saved power level prior to the generator overload. Further, the lowest LED of the power meter display may be equated to no power provided by the generator.

In addition, the control circuit may equate a range of power levels to the other measurements in the power meter display. For example, in the LED power meter display 216, the control circuit may assign each LED in the power meter display a particular percentage based on the 100% power meter reading. Thus, the control circuit may assign one LED of the display to 20% of the last stored power value, 40% of the last stored power value, etc. In this manner, the range of the power meter display is adjusted based on the last stored power value before the generator overload. In power meter displays that display generator power levels that exceed 100%, indicators in the power meter display may be assigned values that exceed the 100% last stored power level. Thus, the power meter display of the transfer switch is recalibrated to the last measured power level of the generator before the generator overload occurred. The power meter display 216 may be recalibrated for any range of power provided by the generator in response to the detected power measurement of generator overload.

Through the learn function described, the power meter 216 on the transfer switch device 200 may be calibrated to account for the type of generator or other alternative power source connected to the load center through the transfer switch. Thus, the power meter display may provide the total range of available power from the generator, regardless of the size or type of generator used. Further, the power provided by the generator at any one time may be presented in a percentage of total available generator power. The percentage displayed by the power meter may adjust according to the type of generator connected to the transfer switch device.

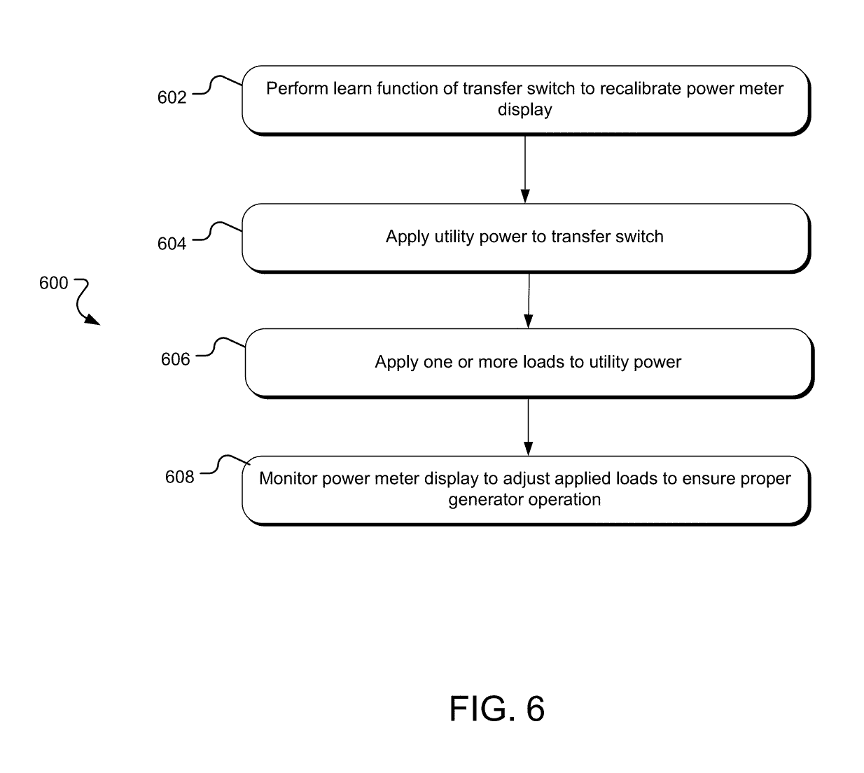

FIG. 6 is a flowchart of a method for utilizing the display of a power meter of a transfer switch when a load center is energized by a utility power to maximize the loaded circuits for the situation where the load center is powered by a generator. The operations of the flowchart of FIG. 6 may be performed by a user of the transfer switch with a learn function, or may be performed by a system associated with the transfer switch to automatically adjust the circuits of the load center to maximize the available circuits powered by a generator.

Beginning in operation 602, the user or the system performs the learn function as described above with relation to FIGS. 4 and 5. In general, the learn function recalibrates a power meter display on the transfer switch to indicate the power levels available from a generator associated with the transfer switch. Then, in operation 604, the user or the system utilizes the switches and breakers of the transfer switch to power the load center by the utility power source.

In operation 606, the user or the system begins applying loads to the load center. This may entail energizing additional circuits, appliances or other energy consuming devices on the power provided by the utility. During the addition of loads to the load center, the user or system may monitor the power meter display of the transfer switch in operation 608. By monitoring the power meter display, the user or the system may determine which loads may be supported by the generator when utility power may not be available. In other words, loads may be added to the load center by the user while monitoring the power meter display. As long as the power meter display indicates the power level applied to the load center does not exceed 100% of the available generator power, the generator is likely to support the loads or circuits on the load center. In this manner, the number and types of circuits, components, appliances and the like that the generator supports may be determined by the user or the system to ensure that overloading does not occur at an inopportune time, such as when the utility power source is not available.

As mentioned above, the transfer switch may incorporate a control circuit to control and perform at least one operation of the learn function described above. FIG. 7 is an exemplary control circuit configuration 700 for performing one or more of the operations of a transfer switch system. The control circuit 700 includes two parallel measurement and power systems accordingly, one for each phase measured (labeled in FIG. 7 as “Load Phase A” and “Load Phase B”). In general, each channel of the control circuit 700 measures the power provided by a single phase from a power source (such as a generator as discussed above) and provides a displayed measurement. In one embodiment, the circuit 700 is included with a transfer switch mechanism as discussed above to provide an indication of the percentage of the maximum power available from the alternative power source that is being provided. However, the circuit 700 may be utilized with any system to indicate a percentage of power provided by a power source to a load or load center.

Each measurement channel includes a current transformer (CT) 724, 726 magnetically coupled to one or more phases of the power system, an alternating current to direct current (AC to DC) converter 702, 704, a current sensing circuit 706, 708, and a voltage regulation circuit 710, 712. In general, the CTs 724, 726 output an AC signal with current proportional to the current flowing through the coupled load conductors. The AC to DC converters 702, 704 for each measurement channel convert the AC output from the CTs 702, 704 in a DC signal. The DC signals from the AC to DC converters 702, 704 are transmitted to the current sensing circuits 706, 708 that generate a signal with voltage proportional to the current flowing through the sensing circuit. The output signals from the current sensing circuits 706, 708 are transmitted to an analog to digital converter (ADC) 716. The ADC 716, in turn, outputs a digital representation of the measured output current provided by the current sensing circuits 706, 708 to a processor 718 or processing circuit. In another embodiment, the ADC 716 functionality is performed by the processor 718 through the execution of one or more instructions such that the output signals from the current sensing circuits 706, 708 are transmitted to the processing device. The outputs from the ADC 716 may serve as the power level for each phase of the generator power that is stored by the processor 718 when performing the learn function described above.

The processor 718 includes any general purpose processor, microcontroller, computer or the like and includes one or more memory devices 722 for storing instructions. The memory devices 722 may include a dynamic storage device or a random access memory (RAM) or other computer-readable devices coupled to the processor 718 for storing information and instructions to be executed by the processor. Execution of the instructions or program contained in memory devices 722 may cause the processor 718 to perform one or more process steps. Further, the power levels provided by the generator during the learn function described above may be stored in the one or more memory devices 722 associated with the processor 718. In alternative embodiments, circuitry may be used in place of or in combination with the software instructions. Thus, embodiments of the present disclosure may include both hardware and software components.

In general, the processor 718 may execute a program that is stored in the memory, where the program instructs the processor to monitor the received current measurements from the ADC 716 until the provided power drops to near zero, indicating a stalling or overloading state of the connected generator. During the monitoring stage of the program, the processor 718 may periodically or continually store the largest provided power level from the generator to the one or more memory devices 722. Also, the processor 718 may utilize the last stored value prior to detecting the power drop from the generator to near zero as the maximum available power from the generator. This value may then be used as described herein to adjust a power meter display of the power transfer switch in accordance to the detected maximum power from the generator. In this manner, the processor 718 and/or other components of the circuit 700 may perform any of the methods or operations described herein.

In addition, the processor 718 may also execute a program that is stored in the memory that instructs the processor to compare the received current measurements from the ADC 716 to a maximum output current value stored in the memory of the processor. Through this comparison, a percentage of the received current value of the maximum output current value is calculated. In general, the calculated percentage is a percentage of provided power (for each phase of the provided power, in one embodiment) from an alternative power source, such as a generator. For example, the received current value may be 70% of the stored maximum output current, indicating that the transfer switch device is receiving 70% of the power available from the generator, in that particular phase. Once calculated, the processor generates one or more instructions for activating one or more LEDs or other indicators of a display 720. In one embodiment, the instructions from the processor 718 to the display 720 include energizing the one or more LEDs to activate the LED indicators. The instructions from the processor 718 thus activate the one or more LEDs to provide an indication of the calculated percentage of power being provided by the alternative power source, either in total or for the phases of the provided power.

In one example, the control circuit 700 is configured to draw power from the utility or generator power source through a magnetically coupled current transformer to power the various components of the control circuit 700. For example, voltage regulators 710, 712 may be included in the circuit 700 configured to receive DC power from the AC to DC converters 702, 704. The output of the voltage regulators 710, 712 may be utilized to power one or more of the components of the control circuit 700. For example, the voltage regulator 710, 712 outputs may power the components of the ADC 716, the processor 718 and the display 720. In this manner, one or more of the components of the control circuit 700 may utilize the current delivered by the current transformers to power the components of the circuit. Thus, the use of an off-line power supply, battery, or other connection to obtain power for the circuit is not needed, easing installation of the power meter 700, easing compliance with safety standards, and reducing the cost of the device.

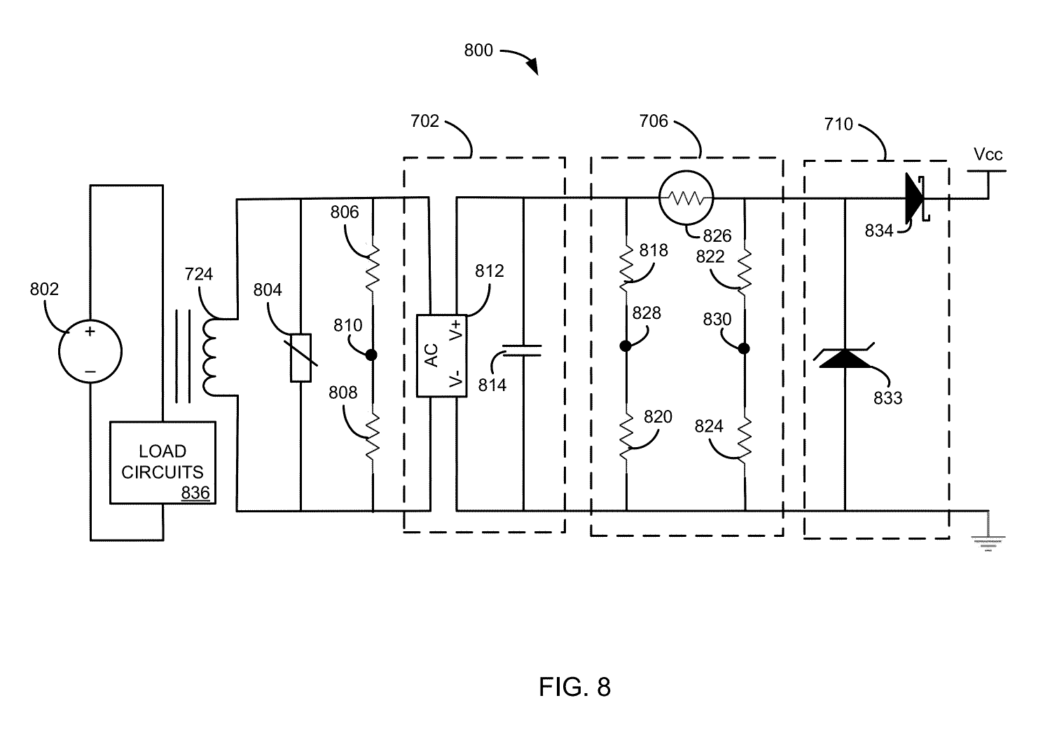

FIG. 8 is a schematic of one embodiment of a meter circuit for a power transfer switch with a learn function. In particular, the circuit 800 is one embodiment of a portion of the circuit diagram 700 discussed above with relation to FIG. 7. In general, the circuit 800 of FIG. 8 provides the current transformer 724, AC to DC converter 702, the current sensing circuit 706, and the voltage regulation 710 for one measurement channel, typically monitoring one phase of power provided to the manual transfer switch. It should be appreciated, however, that the circuit 800 of FIG. 8 is but one type of circuit of the meter control circuit and that many other circuit components and constructions may be used to perform the components of the meter control circuit.

As mentioned, the circuit 800 receives the output of a current transformer 724 magnetically coupled to one phase of a multi-phase power source, such as a generator or utility power source, that provides power to one or more load circuits 836. Connected across the output of the current transformer 802 is a varistor component 804 to provide overvoltage protection to the circuit 800. Further connected in parallel to the varistor 804 are a first set of two in series resistors 806, 808. A connection node 810 is located between the first set of resistors 806, 808 to provide a connection point within the circuit for detecting a drop or change in the frequency of the provided power from the power source 802. This detection node 810 may be used to determine an overload condition of the power source 802 for use with the learn function of the system discussed above. For example, the signal at the detection node 810 may be provided to the ADC 716 as an input, which in turn provides a digital representation of the input to the processor 718. The processor 718 may monitor the input as described above to detect when the frequency of the power signal at the detection node 810 changes. In one embodiment, the processor 718 is configured to detect a particular type of change in the frequency that indicates an overload or stalling of the power source 802. Once detected at the input from the detection node 810, the processor 718 may store the last received power level from the power source as the maximum available power source, as described. In this manner, the processor 718 may be electrically connected to the detection node 810 to receive the signal at that node as part of the operations described above to detect the maximum power provided by the power source 802.

Further connected in parallel with the two resistors 806, 808 is the AC to DC conversion portion 702 of the circuit 800 including a wave rectifier diode bridge 812 and a capacitor 814 connected in parallel with the wave rectifier. The current sensing circuit 704 is connected to the AC to DC conversion circuit 702. The current sensing circuit 704 includes a second set of resistors 818, 820 connected in series to each other, a third set of resistors 822, 824 connected in series to each other, and a current sensing resistor 826 connected between one of the resistors 818 of the second set of resistors and one of the resistors 822 of the third set of resistors. A high side connection node 828 is located between the resistors 818, 820 of the second set of resistors and a low side connection node 830 is located between the resistors 822,824 of the third set of resistors. In one embodiment, the processor 718 may be connected to the high side connection node 828 and the low side connection node 830 to compare the voltage at each node and determine the current through the known current sensing resistor 826. This determination by the processor 718 of the current through the current sensing resistor 826 based on the voltage at the high side connection node 828 and the low side connection node 830 may be used by the processor to determine the power provided by the power source 802 to the load center associated with the manual transfer switch where the processor 718 approximates the power source as a known, fixed-voltage source.

In addition, a voltage regulator circuit 710 may be connected to the current sensing circuit 706. The voltage regulator circuit 710 may include a zener diode 833 connected in parallel with the current sensing circuit 706 and a Schottky diode 834 connected with the regulator output, its anode connected to the zener diode's cathode. These components may operate to provide power to other components of the LED meter circuit as discussed above, such as the processor 718 and the display 720, and the blocking diode 834 permits multiple measurement channel circuits to contribute current to the other components of the LED meter circuit without interfering with each other's measurements. In this manner, power is provided to operate the components of the meter circuit from the CT signal and not, necessarily, directly from the power source 802 of from a battery that would need to be replaced periodically.

In other embodiments of the LED meter circuit, the processor 718 may include one or more of the components of the circuit 800 discussed in FIG. 8. More particularly, the processor 718 may execute instructions that cause the processor to perform the function of one or more of the components portions of the circuit 800. Further, additional components may also be utilized with the circuit 800 to provide additional functionality to the component portions or the circuit overall without taking away from the general operation of the LED meter circuit described herein.

Embodiments of the present disclosure include various operations, which are described in this specification. The operations may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

The foregoing merely illustrates the principles of the invention. Various modifications and alterations to the described embodiments will be apparent to those skilled in the art in view of the teachings herein. It will thus be appreciated that those skilled in the art will be able to devise numerous systems, arrangements and methods which, although not explicitly shown or described herein, embody the principles of the invention and are thus within the spirit and scope of the present invention. From the above description and drawings, it will be understood by those of ordinary skill in the art that the particular embodiments shown and described are for purposes of illustrations only and are not intended to limit the scope of the present invention. References to details of particular embodiments are not intended to limit the scope of the invention.

We claim:

1. A manual transfer switch, the switch comprising:
a switch comprising a first position that provides power from a first power source to a load center in electrical communication with the manual transfer switch and a second position that provides power from a second power source to the load center;
a power meter for displaying an indication of a power level provided to the load center; and
a control circuit comprising a processor and at least one memory device, the processor executing one or more instructions stored in the at least one memory device, the instructions causing the control circuit to:
monitor the second power source for an overload condition of the second power source;
detect the overload condition of the second power source;
store a maximum power level of the second power source in the at least one memory device, the maximum power level of the second power source associated with the overload condition of the second power source; and
calculate a percentage of the maximum power provided to the load center from the second power source, the percentage of the maximum power comprising a current power provided by the second power source to the load center divided by the maximum power level of the second power source;
wherein the indication of the power level of the second power source provided to the load center is the calculated percentage of maximum power.

2. The manual transfer switch of claim 1 wherein the second power source is a generator.

3. The manual transfer switch of claim 1 further comprising an activator, wherein engagement of the activator begins the execution of the one or more instructions by the processor.

4. The manual transfer switch of claim 1 wherein executing the one or more instructions stored in the at least one memory device by the processor further causes the control circuit to:
periodically store a provided power level from the second power source during monitoring the second power source for the overload condition.

5. The manual transfer switch of claim 4 wherein detecting the overload condition of the second power source comprises receiving an indication of a drop in the provided power from the second power source.

6. The manual transfer switch of claim 5 wherein the drop in the provided power from the second power source indicates stalling of the second power source.

7. The manual transfer switch of claim 1 wherein the power meter display comprises a plurality of light emitting diodes.

8. The manual transfer switch of claim 7 wherein executing the one or more instructions stored in the at least one memory device by the processor further causes the control circuit to:
transmit at least one signal to the power meter to cause at least one of the plurality of light emitting diodes to illuminate, the at least one of the plurality of light emitting diodes corresponding to the calculated percentage of maximum power.

9. The manual transfer switch of claim 1 wherein the power meter display comprises a digital read-out device displaying the calculated percentage of maximum power.

10. A method for calibrating a power meter of a power transfer device, the method comprising:
monitoring a provided power from a power source in electrical communication with the manual transfer device;
detecting an overload condition of the power source;
storing a maximum power level of the source in at least one memory device of a power meter display control circuit, the maximum power level of the power source associated with the overload condition of the power source;
calculating a percentage of the maximum power provided to a load center connected to the power transfer device from the power source, the percentage of the maximum power comprising a current power provided by the power source to the load center divided by the maximum power level of the power source; and
displaying the calculated percentage of maximum power on the power meter associated with the manual transfer device.

11. The method of claim 10 further comprising:
adding loads to the load center to increase the provided power from the power source in electrical communication with the manual transfer device and cause the overload condition.

12. The method of claim 11 further comprising:
periodically storing the provided power level from the power source during the adding loads to the load center to increase the provided power from the power source in electrical communication with the manual transfer device.

13. The method of claim 10 wherein the power meter comprises a plurality of light emitting diodes.

14. The method of claim 13 wherein displaying the calculated percentage of maximum power on the power meter associated with the manual transfer device comprises:
transmitting at least one signal to the power meter to cause at least one of the plurality of light emitting diodes to illuminate, the at least one of the plurality of light emitting diodes corresponding to the calculated percentage of maximum power.

15. The method of claim 10 further comprising:
receiving an activation signal from an activator device, wherein the activation signal begins the monitoring a provided power from a power source in electrical communication with the manual transfer device.

16. The method of claim 10 wherein the power source is a generator.

17. The method of claim 10 wherein detecting the overload condition of the power source comprises:
receiving an indication of a drop in the provided power from the power source.

18. The method of claim 17 wherein the drop in the provided power from the power source indicates stalling of the power source

19. A system for providing power to a site, the system comprising:
a generator;
a load center; and
a manual transfer switch in electrical communication between the generator and the load center, the manual transfer switch comprising:
a power meter for displaying an indication of a power level of the generator provided to the load center; and
a control circuit comprising a processor and at least one memory device, the processor executing one or more instructions stored in the at least one memory device, the instructions causing the control circuit to:
monitor a provided power level from the generator for an overload condition of the generator;
store a maximum power level of the generator in the at least one memory device, the maximum power level of the generator associated with the overload condition of the generator; and
calculate a percentage of the maximum power provided to the load center from the generator, the percentage of the maximum power comprising a current power provided by the generator to the load center divided by the maximum power level of the generator;
wherein the indication of the power level of the generator provided to the load center is the calculated percentage of maximum power.

20. The system of claim 19 wherein the power meter comprises a plurality of light emitting diodes.

21. The system of claim 20 wherein executing the one or more instructions stored in the at least one memory device by the processor further causes the control circuit to:
transmit at least one signal to the power meter to cause at least one of the plurality of light emitting diodes to illuminate, the at least one of the plurality of light emitting diodes corresponding to the calculated percentage of maximum power.

22. The system of claim 19 wherein the power meter comprises a digital read-out device displaying the calculated percentage of maximum power.
